(19) United States
(12) Patent Application Publication
(10) Pub. No.: US 2023/0234294 A1
(43) Pub. Date: Jul. 27, 2023

(54) SELECTING THREE-DIMENSIONAL (3D) PRINTING TECHNIQUE AND LOCATION OF 3D-PRINTED SENSORS

(71) Applicant: Kyndryl, Inc., New York, NY (US)

(72) Inventors: Cesar Augusto RODRIGUEZ BRAVO, Alajuela (CR); David Alonso CAMPOS BATISTA, Aurora (CR); Sarbajit K. RAKSHIT, Kolkata (IN)

(21) Appl. No.: 17/585,088

(22) Filed: Jan. 26, 2022

(51) Int. Cl. B29C 64/393; G05B 19/4099; B33Y 50/02

(52) U.S. Cl. CPC B29C 64/393; G05B 19/4099; B33Y 50/02; G05B 2219/35134

(57) ABSTRACT

Aspects of the present disclosure relate generally to selecting a 3D printing technique and location of a sensor as part of a 3D object. For example, a computer-implemented method includes: receiving, by a computing device, a 3D print file specifying a 3D object for printing on a 3D printer; identifying, by the computing device, a technique for printing a sensor as part of the 3D object from a plurality of techniques for printing the sensor as part of the 3D object; determining, by the computing device, a location for printing the sensor as part of the 3D object; adding, by the computing device, the technique and the location for printing the sensor as part of the 3D object to the 3D print file; and sending to the 3D printer the 3D print file with the technique and the location for printing the sensor as part of the 3D object.

### BACKGROUND

Aspects of the present invention relate generally to three-dimensional (3D) printing and, more particularly, to selecting a 3D printing technique and location for 3D printing of a sensor as part of a 3D object.

Three-dimensional (3D) printing is continuing to evolve the capability to 3D print increasingly complex 3D objects. One capability, for example, is 3D printing of different types of sensors with the 3D object. A 3D-printed sensor may allow a 3D object to gather information about the environment in which the 3D object may operate, other objects with which the 3D object may interact, and the 3D object itself. These sensors can be used for many applications in many fields, including medical instruments and devices, industrial deployment of 3D printed parts, and advanced prototyping to name a few.

In engineering, for instance, various physical quantities may be measured and converted to electrical signals using sensors. To this end, 3D-printed mechanical sensors have been produced to measure force, displacement, pressure, strain, and acceleration. For example, 3D-printed strain sensors, which may transduce tensile or compressive strains to electrical signals, have been fabricated from the composition of a flexible conduction material, embedded or attached to a stretchable material. 3D-printed temperature sensors may be used to measure temperature of the air or water. In addition, 3D-printed tactile sensors may be used to measure contact pressure between surfaces. And 3D-printed particle sensors may be used to detect particulate matter in assessing pollutants. In medicine, 3D-printed biomedical sensors may be used to detect and measure enzyme concentrations, microbial pathogens, cell toxicity and heart disease. Accordingly, 3D-printed sensors may be used in a wide variety of applications, including tactile sensing in robotics and in smart clothing to detect the movement of the wearer.

Given the advances in fabrication of complex 3D-sensors, global growth in development of promising 3D-printed sensors is expected. Accompanying this growth of 3D- printed sensors will be many innovative 3D devices using these 3D sensors.

### SUMMARY

In a first aspect of the invention, there is a computer-implemented method including: receiving, by a computing device, a 3D print file specifying a 3D object for printing on a 3D printer; identifying, by the computing device, a technique for printing a sensor as part of the 3D object from a plurality of techniques for printing the sensor as part of the 3D object; determining, by the computing device, a location for printing the sensor as part of the 3D object; adding, by the computing device, the technique and the location for printing the sensor as part of the 3D object to the 3D print file; and sending to the 3D printer the 3D print file with the technique and the location for printing the sensor as part of the 3D object added to the 3D print file.

In another aspect of the invention, there is a computer program product including one or more computer readable storage media having program instructions collectively stored on the one or more computer readable storage media. The program instructions are executable to: receive, by a computing device, a 3D print file specifying a 3D object for printing on a 3D printer; determine, by the computing device, a location for printing the sensor as part of the 3D object; add, by the computing device, a location for printing the sensor as part of the 3D object to the 3D print file specifying the 3D object for printing on the 3D printer; and print the 3D object using the print file with the technique and the location of printing the sensor.

In another aspect of the invention, there is a system including a processor, a computer readable memory, one or more computer readable storage media, and program instructions collectively stored on the one or more computer readable storage media. The program instructions are executable to: receive, by the processor, a 3D print file specifying a 3D object for printing on a 3D printer; identify, by the processor, a technique for printing a sensor as part of the 3D object from a plurality of techniques for printing the sensor as part of the 3D object; determine, by the processor, a location for printing the sensor as part of the 3D object; add, by the processor, a specification of the technique and the location for printing the sensor as part of the 3D object to the 3D print file specifying the 3D object for printing on the 3D printer; store on the one or more computer readable storage media, by the processor, the 3D print file with the specification of the technique and the location for printing the sensor as part of the 3D object added to the 3D print file specifying the 3D object for printing on the 3D printer; and send the 3D print file to the 3D printer.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computer infrastructure according to an embodiment of the present invention.

FIG. 2 shows a block diagram of an exemplary environment in accordance with aspects of the invention.

FIGS. 3A-3B depict exemplary printing techniques in accordance with aspects of the invention.

FIG. 4 shows a flowchart of an exemplary method in accordance with aspects of the invention.

FIG. 5 shows a flowchart of an exemplary method in accordance with aspects of the invention.

FIGS. 6A-6B depict exemplary printing locations in accordance with aspects of the invention.

FIG. 7 shows a flowchart of an exemplary method in accordance with aspects of the invention.

### DETAILED DESCRIPTION

Aspects of the present invention relate generally to 3D printing and, more particularly, to selecting a 3D printing technique and location for 3D printing of a sensor as part of a 3D object. According to aspects of the invention, the methods, systems and program products described herein may compare operational attributes of a 3D object with operational attributes of various 3D printing techniques for 3D printing of the sensor and selecting a printing technique for 3D printing of the sensor as part of the 3D object. In embodiments, the methods, systems and program products described herein may determine the location to print the 3D sensor as part of the 3D object based on the attributes and structure of the 3D object, the attributes of the sensor, and the attributes of the material used to fabricate the 3D-printed object. In this manner, implementations of the invention may determine a printing technique and location, for instance, where there may be strain at structural locations of the 3D object, where structural parts of the 3D object may connect or move, or where a break in the structure occurred in previously failed prints of the 3D object, among other attributes. Based on the attributes of the sensor, attributes of the 3D object, and the attributes of the material used to fabricate the 3D-printed object, implementations of the invention may also determine to embed the sensor at a location below the surface of the 3D object, embed the sensor at a location between layers of materials of the 3D object, or expose the sensor at a location on the surface of the 3D object.

Aspects of the present invention are directed to improvements in computer-related technology. In embodiments, a system including a processor, a computer readable memory, one or more computer readable storage media, and program instructions collectively stored on the one or more computer readable storage media may select a 3D printing technique and a location to print a sensor based on a comparison of operational attributes of a 3D object with operational attributes of various 3D printing techniques. This comparison may also include, for example, the material used for printing of the 3D object, the type of sensor used or needed, attributes of the 3D object such as angles in the 3D object, failures found in previously printed 3D objects, among other attributes and considerations described herein. Additional aspects of the invention make further non-abstract improvements to computer technology. For instance, a system including a processor, a computer readable memory, one or more computer readable storage media, and program instructions collectively stored on the one or more computer readable storage media may determine to embed the sensor at a location below the surface of the 3D object, embed the sensor at a location between layers of materials of the 3D object, or expose the sensor at a location on the surface of the 3D object, among other substantial, non-trivial technological improvements. Implementations of the invention describe additional elements that are specific improvements in the way computers may operate and these additional elements provide non-abstract improvements to computer functionality and capabilities.

It should be understood that, to the extent implementations of the invention collect, store, or employ personal information provided by, or obtained from, individuals (for example, an operator's skill level in operation of a 3D-printed object), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

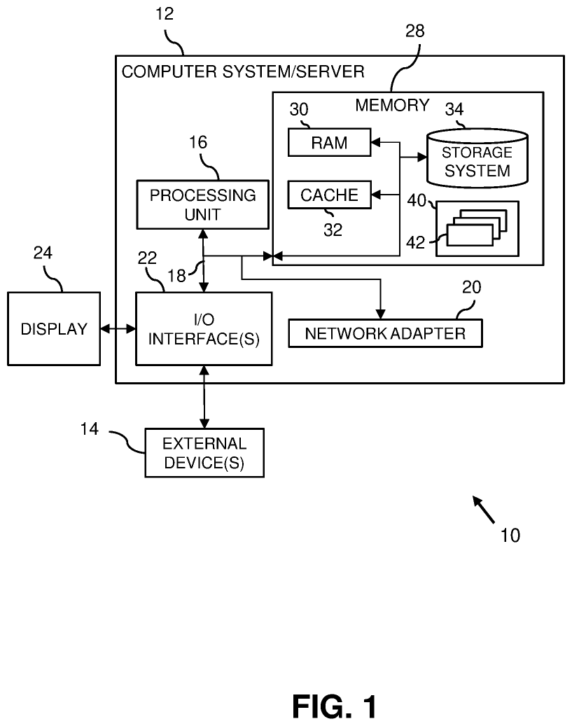

Referring now to FIG. 1, a schematic of an example of a computer infrastructure is shown. Computer infrastructure 10 is only one example of a suitable computer infrastructure and is not intended to suggest any limitation as to the scope of use or functionality of embodiments of the invention described herein. Regardless, computer infrastructure 10 is capable of being implemented and/or performing any of the functionality set forth hereinabove.

In computer infrastructure 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computer infrastructure 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

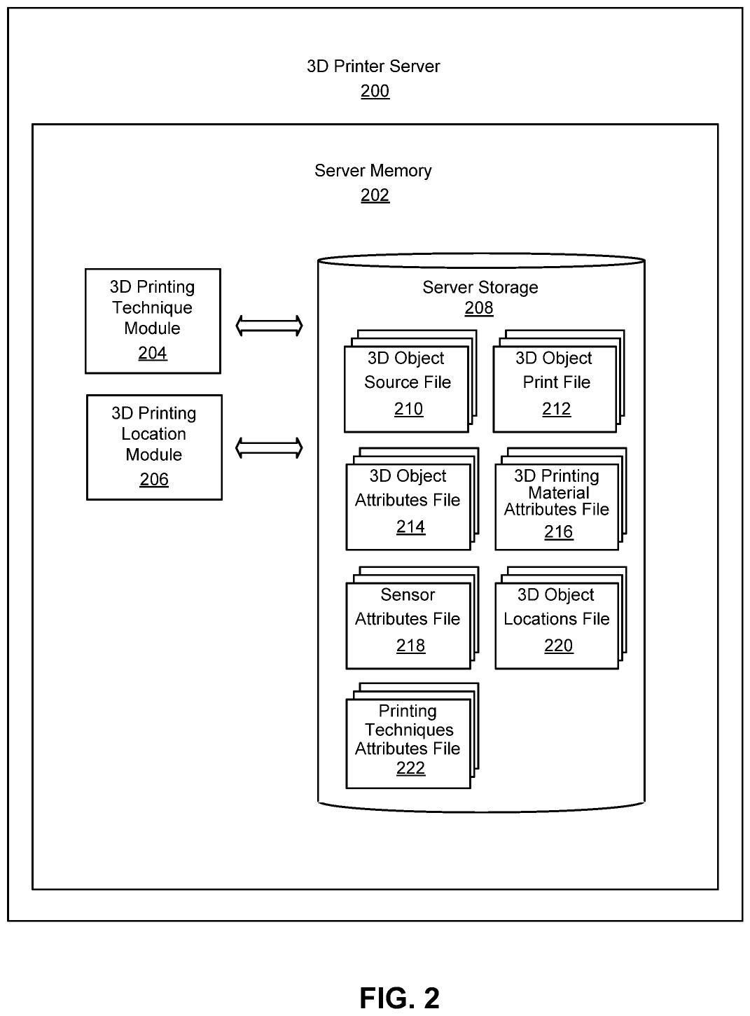

FIG. 2 shows a block diagram of an exemplary environment in accordance with aspects of the invention. In embodiments, the environment includes a 3D printer server 200, which may be a computer system such as computer system 12 described with respect to FIG. 1, and a server memory 202 such as memory 28 described with respect to FIG. 1. In general, the 3D printer server 200 may support services for selecting a 3D printing technique and location for 3D printing of a sensor as part of a 3D object. The 3D printer server 200 may include, in memory 202, a 3D printing technique module 204 having functionality to compare operational attributes of a 3D object with operational attributes of various 3D printing techniques for 3D printing of the sensor and to select a printing technique for 3D printing of the sensor as part of the 3D object. The 3D printer server 200 may also include, in memory 202, a 3D printing location module 206 having functionality to determine the location where to 3D print the sensor as part of the 3D object based on the attributes and structure of the 3D object, the attributes of the sensor, and the attributes of the material used to fabricate the 3D-printed object.

In embodiments, the 3D printing technique module 204 and the 3D printing location module 206 may each comprise one or more program modules such as program modules 42 described with respect to FIG. 1. The 3D printer server 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the 3D printer server 200 may also include, in memory 202, server storage 208 which may be computer storage such as system storage 34 described with respect to FIG. 1. In embodiments, server storage 208 may store information for 3D models in a 3D object source file 210, information for printing a 3D model from a 3D object source file in a 3D object print file 212, information of 3D object attributes in a 3D object attributes file 214, information of 3D printing material attributes in a 3D printing material attributes file 216, information of sensor attributes in a sensor attributes file 218, information of 3D object locations of previous failed prints in a 3D object locations file 220, and information of printing technique attributes in a printing technique attributes file 222. Each of these files and modules may be used to assess the type of sensor required, the location of the sensor in the printed 3D object, in addition to the required attributes of the 3D object in order to assess the need, location and type of sensor to be printed with the 3D object.

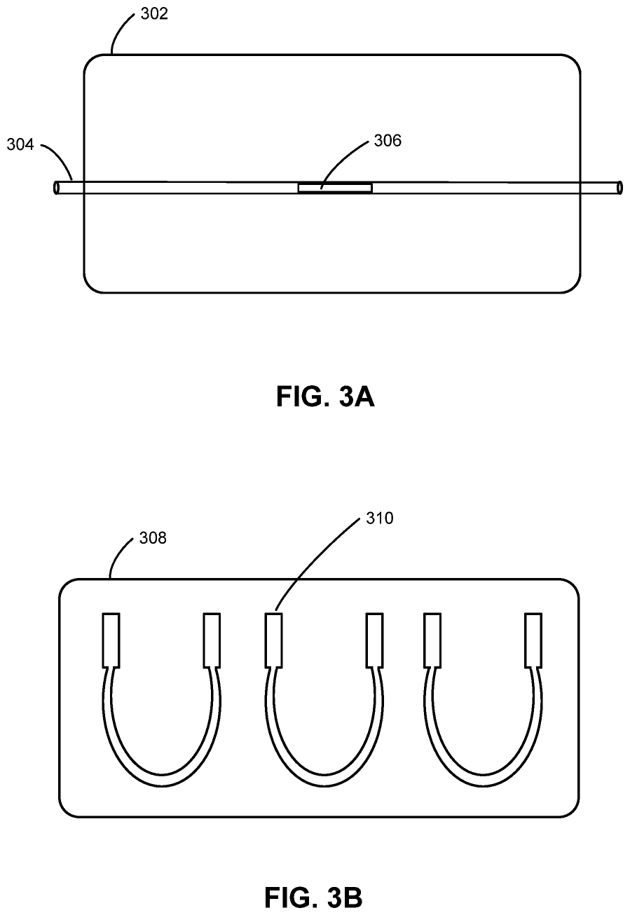

FIGS. 3A-3B depict sensors embedded in 3D objects using exemplary printing techniques, in accordance with aspects of the invention. For example, FIG. 3A illustrates an optic fiber 304 embedded in a thermoplastic fabrication of a 3D printed object 302. The optic fiber 304 is constructed, for example, with a sensor 306 built into the optic fiber 304 to monitor the internal temperature and strain shifts of a 3D printed object 302. To print the 3D object with the embedded optic fiber, a 3D printing technique is used for embedding a sensor in the 3D object during the 3D printing process. In this example, the 3D object may be a 3D printed part that is designed to have a tubular cavity sized to fit an optical fiber running through the 3D printed part. At the point the lower half of the tubular cavity is formed in the 3D printed part, the printer may be paused and the optical fiber laid into the open half-formed tubular cavity of the thermoplastic fabrication of the 3D printed part. Printing can then be resumed to complete fabrication of the tubular cavity surrounding the optical fiber inserted in the 3D printed part. Those skilled in the art appreciate that this process may be repeated to embed other optic fibers constructed with a sensor into fabrication of the 3D printed part.

FIG. 3B depicts sensors embedded in a 3D object using another exemplary printing technique, in accordance with aspects of the invention. For example, FIG. 3B illustrates a soft strain sensor 310 embedded in the thermoplastic fabrication of a 3D printed object 308. To print the 3D object with the embedded strain sensor, a 3D printing technique is used that directly prints the sensor as part of the fabrication of the 3D object. In this example, the soft strain sensor 310 is a U-shaped soft strain sensor with contact pads at each end to facilitate electrical connections and is part of the design of the 3D printed object 308. A direct inkwriting method applying a piezoresistive ink printed on an elastomeric matrix can be used to print the sensor during fabrication of the 3D object.

It should be understood that many other printing techniques may be implemented in accordance with aspects of the present invention. For example, those skilled in the art should appreciate other direct printing techniques may be used for embedding a sensor in a 3D object by directly printing the sensor as part of the fabrication of the 3D object. For instance, another direct printing technique, known as embedded three-dimensional (EMB3D) printing, extrudes functional inks through nozzles within viscoplastic matrix materials. EMB3D involves the simultaneous fabrication of a matrix and an embedded sensor by directly printing a functional ink, such as ionic liquid ink, within viscoplastic matrix materials, such as an elastomeric matrix. The type of functional ink and type of viscoplastic matrix material may be selected for the type and desired characteristics of the sensor or, furthermore, a network of sensors. As an example, a piezoresistive ink within an elastomeric matrix may be selected to print a 3D strain sensor. And an ionic liquid ink that has high thermal stability and high conductivity may be selected to print a tactile sensor within an elastomeric matrix.

Accordingly, the system of the present invention selects a printing technique based on a comparison of operational attributes of a 3D object with operational attributes of various 3D printing techniques. In embodiments, such operational attributes may include environmental and operational conditions, for example, but are not limited to, operator's skills, duration of working life, wear and tear, corrosion, heat generation, water exposure, sunlight exposure, temperature operational range, and humidity operational range.

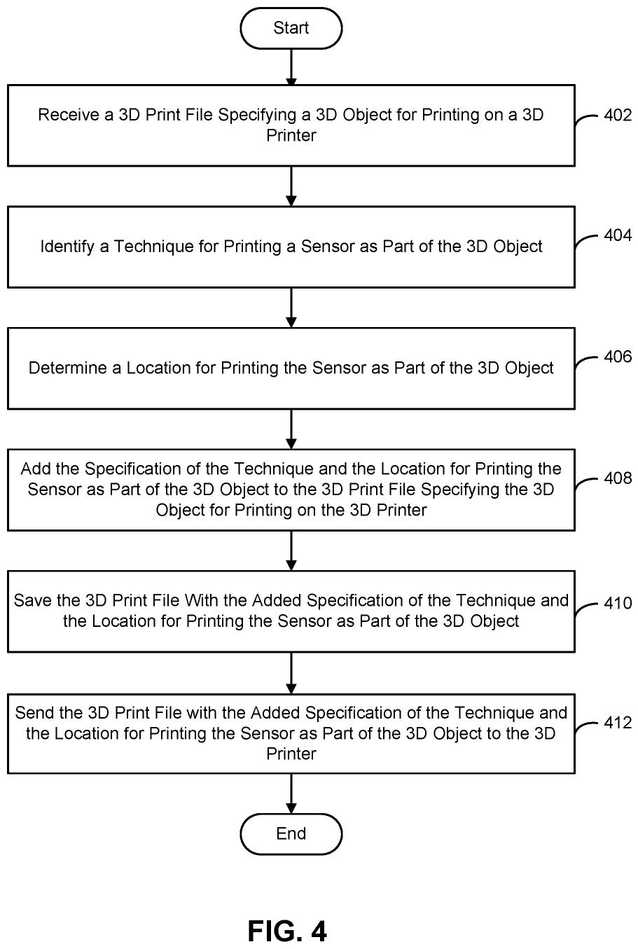

FIGS. 4, 5 and 7 are flowcharts showing exemplary methods of implementing aspects of the present invention. As previously noted, each block in the flowcharts or block diagrams may represent a module, segment, or portion of instructions, which comprises one or more executable instructions for implementing the specified logical function(s). In some alternative implementations, some of the blocks shown in the flowchart may be executed and other blocks not executed, depending upon the functionality involved. Although the blocks in the flowchart show many different attributes such as moving parts, potential sensor damage, attributes of the material used in fabrication, and so forth, those skilled in the art will appreciate that any combination of these different attributes shown can be used in deciding the printing technique and location of a sensor.

More specifically, FIG. 4 shows a flowchart of an exemplary method in accordance with aspects of the present invention. Steps of the method may be carried out in the environment of FIG. 2 and are described with reference to elements depicted in FIG. 2. At step 402, the system receives a 3D print file specifying a 3D object for printing on a 3D printer. In embodiments, the 3D printer server 200 as shown in FIG. 2 receives a 3D print file 212 specifying a 3D object modeled in a 3D object source file 210 for printing on a 3D printer.

At step 404, the system identifies a technique for printing a sensor as part of the 3D object. In embodiments, the 3D printing technique module 204 as shown in FIG. 2 identifies a printing technique for printing the sensor as part of the 3D object based upon a comparison of operational attributes of various 3D printing techniques stored in the printing technique attributes file 222 with operational attributes of the 3D object stored in the 3D object attributes file 214. In embodiments, such operational attributes may include environmental and operational conditions, for example, but are not limited to, operator's skills, duration of working life, wear and tear, corrosion, heat generation, water exposure, sunlight exposure, temperature operational range, and humidity operational range. For example, given a 3D part with operational attributes indicating a duration of working for years and continual wear and tear, the system may select embedding a strain sensor using a printing technique that embeds a preconstructed sensor in the fabrication of a 3D object by insertion during the 3D printing process

At step 406, the system determines a location for printing the sensor as part of the 3D object. In embodiments, the 3D printing location module 206 as shown in FIG. 2 determines the location where to 3D print the sensor as part of the 3D object based on the structure of the 3D object, information of the attributes of the object stored in the 3D object attributes 214, information of the attributes of the sensor stored in the sensor attributes file 218, and information of the attributes of the material used to fabricate the 3D-printed object stored in the 3D printing material attributes file 216.

At step 408, the system adds the specification of the printing technique and the location for printing the sensor as part of the 3D object to the 3D print file specifying the 3D object for printing on the 3D printer. In embodiments, the 3D printer server 200 as shown in FIG. 2 adds the specification technique and the location for printing the sensor as part of the 3D object to a 3D object print file 212.

At step 410, the system saves the 3D print file with the added specification of the printing technique and the location for printing the sensor as part of the 3D object. In embodiments, the 3D printer server 200 as shown in FIG. 2 saves the 3D print file with the added specification of the printing technique and the location for printing the sensor as part of the 3D object to a 3D object print file 212.

At step 412, the system sends the 3D print file with the added specification of the printing technique and the location for printing the sensor as part of the 3D object to the 3D printer. In embodiments, the 3D printer server 200 as shown in FIG. 2 sends a 3D object print file 212 with the added specification of the printing technique and the location for printing the sensor as part of the 3D object to a 3D printer.

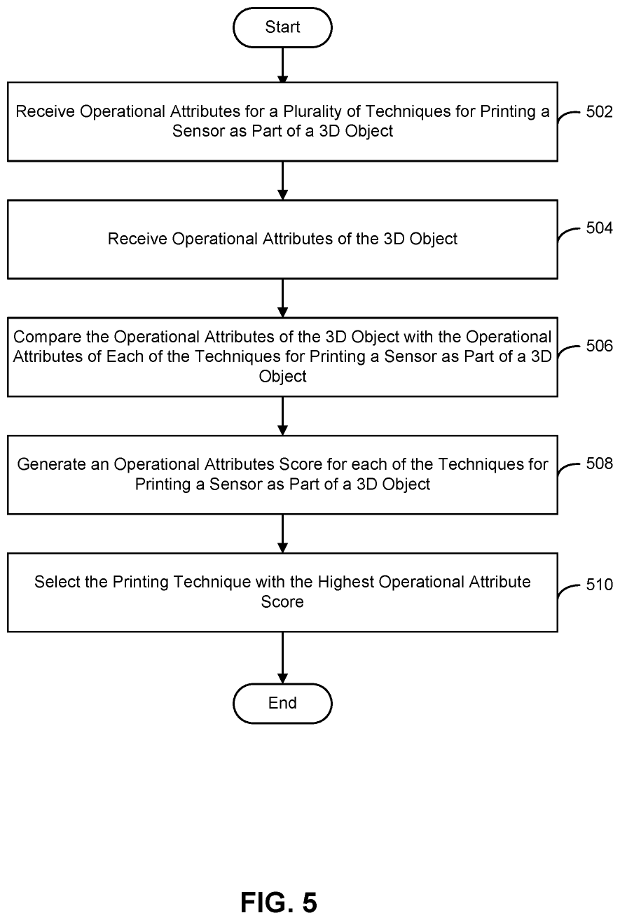

FIG. 5 shows a flowchart of an exemplary method in accordance with aspects of the present invention. Steps of the method may be carried out in the environment of FIG. 2 and are described with reference to elements depicted in FIG. 2.

At step 502, the system receives operational attributes for a plurality of techniques for printing a sensor as part of a 3D object. In embodiments, the 3D printing technique module 204 as shown in FIG. 2 receives information of operational attributes of the printing technique attributes in the printing technique attributes file 222 for printing a sensor as part of a 3D object. For example, operational attributes of a printing technique include, without limitation, duration of working of the 3D object with the embedded sensor, life of the 3D object with the embedded sensor, wear and tear of the 3D object with the embedded sensor, corrosion exposure of the 3D object with the embedded sensor, heat generation of the 3D object with the embedded sensor, water exposure of the 3D object with the embedded sensor, sunlight exposure of the 3D object with the embedded sensor, temperature operational range of the 3D object with the embedded sensor, and humidity operational range of the 3D object with the embedded sensor.

At step 504, the system receives operational attributes of the 3D object. In embodiments, the 3D printing technique module 204 as shown in FIG. 2 receives information of operational attributes of the 3D object stored in the 3D object attributes file 214. In embodiments, such operational attributes may include environmental and operational conditions, for example, but are not limited to, operator's skills, duration of working life, wear and tear, corrosion exposure, heat generation, water exposure, sunlight exposure, temperature operational range, and humidity operational range of the 3D object.

At step 506, the system may compare the operational attributes of the 3D object with the operational attributes of each of the techniques for printing a sensor as part of a 3D object. In embodiments, the 3D printing technique module 204 as shown in FIG. 2 compares the operational attributes of the 3D object stored in the 3D object attributes file 214 with operational attributes of various 3D printing techniques stored in the printing technique attributes files 222. For example, given a 3D part with operational attributes indicating a duration of working for years and continual wear and tear, the system will compare the values of those operational attributes with the values of the operational attributes of the various printing techniques indicating duration of working of the 3D object with the embedded sensor and wear and tear of the 3D object with the embedded sensor.

At step 508, the system generates an operational attribute score for each of the techniques for printing a sensor as part of a 3D object. In embodiments, the 3D printing technique module 204 as shown in FIG. 2 generates an operational attribute score for each of the techniques for printing a sensor as part of a 3D object by summing the number of operational attributes stored in the printing technique attributes file 222 for each of the printing techniques that match the operational attributes of the 3D object stored in the 3D object attributes file 214. For example, the system generates an operational attribute score by incrementing a sum for each of the operational attributes stored in the printing technique attributes file 222 for each of the printing techniques that match the operational attributes of a 3D part, for instance, indicating a duration of working for years and continual wear and tear.

At step 510, the system selects the printing technique with the highest operational attribute score. In embodiments, the 3D printing technique module 204 as shown in FIG. 2 selects the printing technique with the highest number of operational attributes stored in the printing technique attributes file 222 that match the operational attributes of the 3D object stored in the 3D object attributes file 214. In this way, it is now possible to print a proper type of sensor using an optimal printing technique that takes into account operational attributes of a 3D object with operational attributes of various 3D printing techniques.

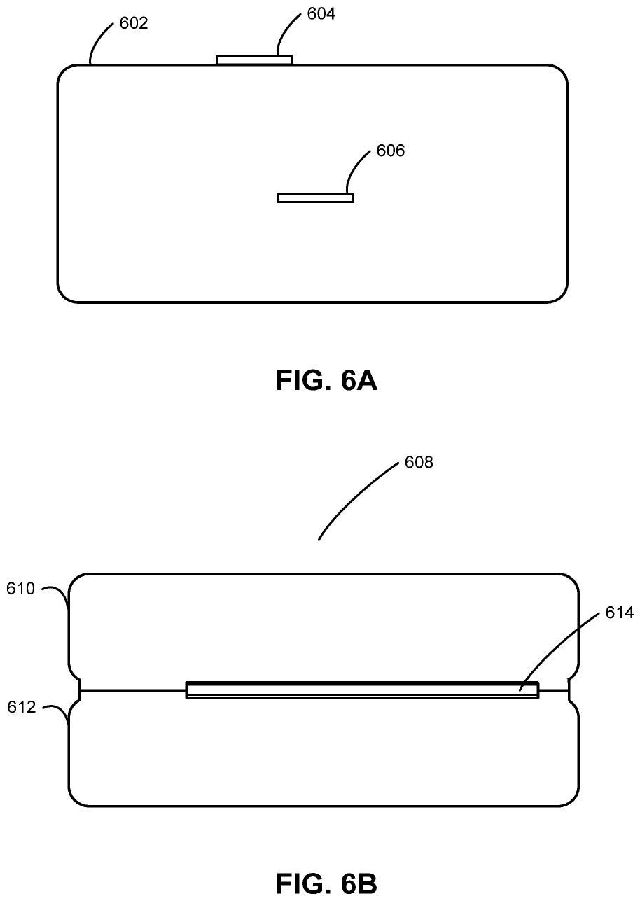

FIGS. 6A-6B depict exemplary printing locations, in accordance with aspects of the invention. Based on the attributes of the sensor, attributes of the 3D object, and the attributes of the material used to fabricate the 3D-printed object, implementations of the invention may determine to embed the sensor at a location below the surface of the 3D object, embed the sensor at a location between layers of materials of the 3D object, or expose the sensor at a location on the surface of the 3D object. For example, FIG. 6A illustrates a cross sectional view of a 3D printed object 602 with two sensors, sensor 604 and sensor 606. Sensor 604 may be printed at a location on the surface of the 3D object, exposing the sensor to elements in the 3D object's environment. Sensor 606 may be embedded at a location below the surface of the 3D object. FIG. 6B illustrates a cross section view of a 3D printed object 608 with a sensor 614 embedded at a location between layers of materials of the 3D object, layer 610 and layer 612. An example of such a 3D printed object with a sensor embedded at a location between layers of material may be a strain sensor embedded between layers of the insole of a shoe.

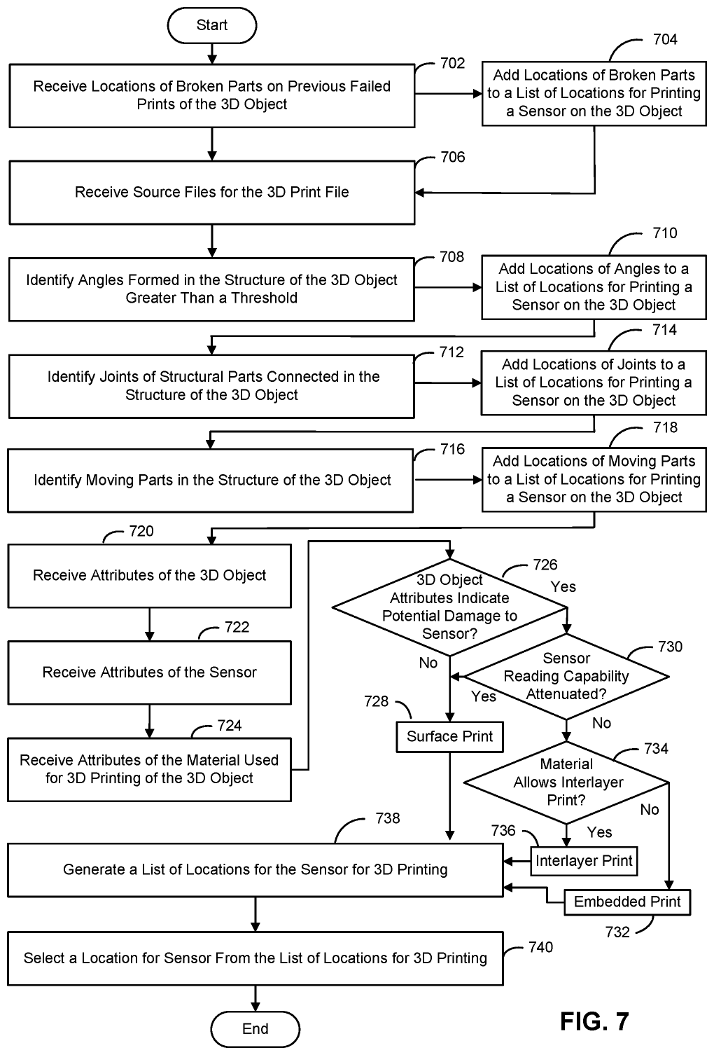

FIG. 7 shows a flowchart of an exemplary method in accordance with aspects of the present invention. Steps of the method may be carried out in the environment of FIG. 2 and are described with reference to elements depicted in FIG. 2.

At step 702, the system receives one or more locations of broken parts on one or more previous failed prints of the 3D object. In embodiments, the 3D printing location module 206 as shown in FIG. 2 receives information of one or more locations of broken parts on one or more previous failed prints of the 3D object from the locations of 3D objects file 220.

At step 704, the system adds locations of broken parts to a list of locations for printing a sensor on the 3D object. In embodiments, the 3D printing location module 206 as shown in FIG. 2 may add locations of broken parts to a list of locations for printing a sensor on the 3D object in memory of server memory 202.

At step 706, the system receives one or more source files for the 3D print file. In embodiments, the 3D printing location module 206 as shown in FIG. 2 may receive one or more 3D object source files 210.

At step 708, the system identifies angles formed in the structure of the 3D object greater than a threshold. In embodiments, the 3D printing location module 206 as shown in FIG. 2 identifies angles formed in the structure of the 3D object greater than a threshold. In a non-limiting illustrative example, the threshold angle may be 45 degrees. In various embodiments, the 3D printing location module 206 may also identify angles formed in the structure of the 3D object with a width of the structure of the 3D object forming the angles greater than a threshold such as, for example, 50 millimeters; although other dimensions and angles are contemplated herein depending on the specific materials used, application or use of the 3D object, including the force, temperature, and so forth exerted on the 3D object, and past experiences such as historic observations of broken locations of the 3D object.

At step 710, the system adds locations of angles exceeding a threshold to a list of locations for printing a sensor on the 3D object. In embodiments, the 3D printing location module 206 as shown in FIG. 2 adds locations of angles exceeding a threshold to a list of locations for printing a sensor on the 3D object in memory of server memory 202.

At step 712, the system identifies joints of structural parts connected in the structure of the 3D object. In embodiments, the 3D printing location module 206 as shown in FIG. 2 identifies joints of structural parts connected in the structure of the 3D object. For example, the system identifies structural components that form a joint of structural parts such as a ball and socket joint, a hinge joint, a swivel joint, a cantilever joint, an annular joint, and so forth.

At step 714, the system adds locations of joints to a list of locations for printing a sensor on the 3D object. In embodiments, the 3D printing location module 206 as shown in FIG. 2 adds locations of joints to a list of locations for printing a sensor on the 3D object in memory of server memory 202.

At step 716, the system identifies moving parts in the structure of the 3D object. In embodiments, the 3D printing location module 206 as shown in FIG. 2 identifies moving parts in the structure of the 3D object. For example, the system identifies structural components that can move in the 3D object such as turnable knobs, hinges, gears, ball bearings, and so forth.

At step 718, the system adds locations of movable parts to a list of locations for printing a sensor on the 3D object. In embodiments, the 3D printing location module 206 as shown in FIG. 2 may add locations of movable parts to a list of locations for printing a sensor on the 3D object in memory of server memory 202.

At step 720, the system receives attributes of the 3D object. In embodiments, the 3D printing location module 206 as shown in FIG. 2 receives information of attributes of the 3D object stored in the 3D object attributes file 214. These attributes may include operational attributes of the 3D object such as environmental and operational conditions, for example, but are not limited to, operator's skills, duration of working life, wear and tear, corrosion exposure, heat generation, water exposure, sunlight exposure, temperature operational range, and humidity operational range.

At step 722, the system receives attributes of the sensor. In embodiments, the 3D printing location module 206 as shown in FIG. 2 receives information of attributes of the sensor stored in the sensor attributes file 218. These attributes may include operational attributes of the sensor such as environmental and operational conditions as already described herein, e.g., duration of working life, wear and tear, corrosion tolerance, water exposure tolerance, sunlight exposure tolerance, temperature operational range, and humidity operational range.

At step 724, the system receives attributes of the material used for 3D printing of the 3D object. In embodiments, the 3D printing location module 206 as shown in FIG. 2 receives information of attributes of the material used for 3D printing of the 3D object stored in the 3D printing material attributes file 216.

At step 726, the system determines whether the 3D object attributes may indicate potential damage to the sensor. In embodiments, the 3D printing location module 206 as shown in FIG. 2 identifies incompatible operational attributes of the sensor and the 3D object by comparing the operational attributes of the sensor stored in the sensor attributes file 218 with operational attributes of the 3D object stored in the 3D object attributes file 214. For example, an operational attribute of the 3D object such as the temperature operation range of the 3D object in its operating environment may exceed the operational attribute of the temperature operational range of the sensor and may accordingly indicate potential damage to the sensor. If the system determines that the 3D object attributes indicate potential damage to the sensor, then the system continues carrying out steps of the exemplary method at step 730. If not, then the system continues carrying out steps of the exemplary method at step 728.

At step 728, the system adds the specification to print the sensor on the surface of the 3D object to the list of locations for printing a sensor on the 3D object. In embodiments, the 3D printing location module 206 as shown in FIG. 2 adds the specification to print the sensor on the surface of the 3D object to the list of locations for printing the sensor on the 3D object in memory of server memory 202. Those skilled in the art will appreciate that the system makes the determination to print the sensor on the surface of a 3D object when the sensor will not be exposed to environmental or operational conditions that may damage the sensor such as exceeding the temperature operational range of the sensor, or exposing the sensor to continual wear and tear, among other damaging environmental or operational conditions. Those skilled in the art will also appreciate that the system determines to print the sensor on the surface of the 3D object when the reading capability of the sensor would otherwise be attenuated if the sensor was embedded within the 3D object.

At step 730, the system determines whether the sensor's reading capability operates unattenuated if embedded. In embodiments, the 3D printing location module 206 as shown in FIG. 2 checks a value of the reading capability attribute of the operational attributes of the sensor stored in the sensor attributes file 218 that indicates whether the sensor can be embedded without attenuation of its reading capability. If the system determines the value indicates the sensor can be embedded without attenuation of its reading capability, then the system continues carrying out steps of the exemplary method at step 734. If not, then the system continues carrying out steps of the exemplary method at step 728.

At step 732, the system adds the specification to embed the sensor at a location below the surface of the 3D object to the list of locations for printing a sensor on the 3D object. In embodiments, the 3D printing location module 206 as shown in FIG. 2 adds the specification to embed the sensor at a location below the surface of the 3D object to the list of locations for printing the sensor on the 3D object in memory of server memory 202. Those skilled in the art will appreciate that the system makes the determination to embed the sensor within a 3D object when doing so would not attenuate the sensor's reading capability and when the sensor will otherwise be exposed to environmental or operational conditions that may damage the sensor such as exceeding the temperature operational range of the sensor, or exposing the sensor to continual wear and tear, among other damaging environmental or operational conditions.

At step 734, the system determines whether the material allows embedding the sensor at a location between layers of materials of the 3D object. In embodiments, the 3D printing location module 206 as shown in FIG. 2 checks a value of the material interlayer attribute of the attributes of the material used for 3D printing of the 3D object stored in the 3D printing material attributes file 216 and checks a value of the reading capability attribute of the operational attributes of the sensor stored in the sensor attributes file 218 that indicates whether the sensor can be embedded without attenuation of its reading capability. If the system determines that the value of the material interlayer attribute of the attributes of the material used for 3D printing of the 3D object indicates the sensor can be embedded at a location between layers of materials of the 3D object and the value of the reading capability attribute of the operational attributes of the sensor indicates the sensor can be embedded without attenuation of its reading capability, then the system continues carrying out steps of the exemplary method at step 736. If not, then the system continues carrying out steps of the exemplary method at step 732.

At step 736, the system adds the specification to embed the sensor at a location between layers of materials of the 3D object to the list of locations for printing a sensor on the 3D object. In embodiments, the 3D printing location module 206 as shown in FIG. 2 adds the specification to embed the sensor at a location between layers of materials of the 3D object to the list of locations for printing the sensor on the 3D object in memory of server memory 202. Those skilled in the art will appreciate that the system makes the determination to embed the sensor at a location between layers of materials of the 3D object when doing so would not attenuate the sensor' reading capability, when the sensor will otherwise be exposed to environmental or operational conditions that may damage the sensor, and when the material allows for interlayer embedding that benefits applications such as athletic apparel exposed to changing weather condition, wear and tear, among other damaging environmental or operational conditions.

At step 738, the system generates a list of locations for printing the sensor on the 3D object. In embodiments, the 3D printing location module 206 as shown in FIG. 2 generates a list of locations in memory of server memory 202 for printing the sensor on the 3D object.

At step 740, the system selects a location for printing the sensor from the list of locations for printing the sensor on the 3D object. In embodiments, the 3D printing location module 206 as shown in FIG. 2 selects a location for printing the sensor from the list of locations for printing the sensor on the 3D object. In an implementation, the 3D printing location module 206 may select the first location from the list of locations for printing the sensor on the 3D object. Accordingly, it is now possible to print a proper type of sensor at an optimal location on the 3D object that takes into account the attributes and structure of the 3D object, the attributes of the sensor, and the attributes of the material used to fabricate the 3D object, among other considerations including operational and environmental conditions.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, a 3D print file specifying a 3D object for printing on a 3D printer;
identifying, by the computing device, an optimal technique for printing a sensor as part of the 3D object from a plurality of techniques for printing the sensor as part of the 3D object;
determining, by the computing device, an optimal location for printing the sensor as part of the 3D object;
adding, by the computing device, the optimal technique and the optimal location for printing the sensor as part of the 3D object to the 3D print file; and
sending to the 3D printer the 3D print file with the optimal technique and the optimal location for printing the sensor as part of the 3D object added to the 3D print file.

2. The method of claim 1, further comprising:
storing the 3D print file with the optimal technique and the optimal location for printing the sensor as part of the 3D object added to the 3D print file.

3. The method of claim 1, further comprising:
receiving, by the computing device, at least one operational attribute of each of the plurality of techniques for printing the sensor as part of the 3D object;
receiving, by the computing device, at least one operational attribute of the 3D object;
comparing, by the computing device, the at least one operational attribute of the 3D object with the at least one operational attribute of each of the plurality techniques for printing the sensor as part of the 3D object;
generating, by the computing device, a score for each of the plurality of techniques for printing the sensor as part of the 3D object based on the comparing; and
selecting, by the computing device, the printing technique of the plurality of techniques for printing the sensor as part of the 3D object with the highest score.

4. The method of claim 1, further comprising identifying, by the computing device, a technique for printing the sensor directly onto a structure of the 3D object.

5. The method of claim 1, further comprising:
receiving, by the computing device, operational attributes of the 3D object indicating at least one location of a broken part on a failed 3D print of the 3D object;
adding, by the computing device, the at least one location to a list of locations for printing the sensor as part of the 3D object; and
selecting, by the computing device, the location of the broken part for the sensor to be printed from the list of locations.

6. The method of claim 1, further comprising:
identifying, by the computing device, at least one angle of the 3D object with an angle size greater than a threshold;
adding, by the computing device, at least one location that forms a part of the at least one angle to a list of locations for printing the sensor as part of the 3D object; and
selecting, by the computing device, the at least one location for the sensor to be printed from the list of locations.

7. The method of claim 1, further comprising:
identifying, by the computing device, at least one joint connected in a structure of the 3D object;
adding, by the computing device, at least one location of the at least one joint to a list of locations for printing the sensor as part of the 3D object; and
selecting, by the computing device, the at least one location for the sensor to be printed from the list of locations.

8. The method of claim 1, further comprising:
identifying, by the computing device, at least one moving part of the 3D object;
adding, by the computing device, at least one location of the at least one moving part to a list of locations for printing the sensor as part of the 3D object; and
selecting, by the computing device, the at least one location for the sensor to be printed from the list of locations.

9. The method of claim 1, further comprising:
identifying, by the computing device, at least one environmental condition of at least one operational attribute of the 3D object;
determining, by the computing device, at least one location for printing the sensor as part of the 3D object based on the at least one environmental condition;
adding, by the computing device, the at least one location to a list of locations for printing the sensor as part of the 3D object; and
selecting, by the computing device, the at least one location for the sensor to be printed from the list of locations.

10. The method of claim 1, further comprising:
receiving, by the computing device, at least one operational attribute of the 3D object;
receiving, by the computing device, at least one operational attribute of the sensor;
determining, by the computing device, that the at least one operational attribute of the 3D object and the at least one operational attribute of the sensor will not damage the sensor;
adding, by the computing device, a specification of printing the sensor at a location that the sensor will not be damaged; and
selecting, by the computing device, the location that the sensor will not be damaged.

11. The method of claim 1, further comprising:
receiving, by the computing device, at least one of an operational attribute of the 3D object, the sensor and a material used by the 3D printer for printing the 3D object;
determining, by the computing device, that the reading ability of the sensor will not be attenuated based the at least one operational attribute of the sensor, the 3D object and the material used; selecting, by the computing device, a location for interlayer printing of the sensor as part of the 3D object.

12. A computer program product comprising one or more computer readable storage media having program instructions collectively stored on the one or more computer readable storage media, the program instructions executable to:
receive, by a computing device, a 3D print file specifying a 3D object for printing on a 3D printer;
determine, by the computing device, a location for printing a sensor as part of the 3D object;
add, by the computing device, the location for printing the sensor as part of the 3D object to the 3D print file specifying the 3D object for printing on the 3D printer; and
print the 3D object using the print file with the technique and the location of printing the sensor.

13. The computer program product of claim 12, wherein the program instructions are further executable to:
receive, by the computing device, at least one location of a broken part on a failed 3D print of the 3D object and
print the sensor at the at least one location of the broken part.

14. The computer program product of claim 12, wherein the program instructions are further executable to:
identify, by the computing device, at least one angle formed in the structure of the 3D object with an angle size greater than a threshold; and
print the sensor at the at least one the angle which is greater than the threshold.

15. The computer program product of claim 12, wherein the program instructions are further executable to:
identify, by the computing device, at least one joint connected in a structure of the 3D object; and
print the sensor at the at least one joint.

16. The computer program product of claim 12, wherein the program instructions are further executable to:
identify, by the computing device, at least one moving part in the structure of the 3D object; and
print the sensor at the at least one moving part.

17. The computer program product of claim 12, wherein the program instructions are further executable to generate an operational attribute score for each technique of printing a sensor as part of the 3D object by summing a number of operational attributes stored in a printing technique attribute file for each of the techniques that match operational attributes of the 3D object.

18. A system comprising:
a processor, a computer readable memory, one or more computer readable storage media, and program instructions collectively stored on the one or more computer readable storage media, the program instructions executable to:
receive, by the processor, a 3D print file specifying a 3D object for printing on a 3D printer;
identify, by the processor, a technique for printing a sensor as part of the 3D object from a plurality of techniques for printing the sensor as part of the 3D object;
determine, by the processor, a location for printing the sensor as part of the 3D object;
add, by the processor, a specification of the technique and the location for printing the sensor as part of the 3D object to the 3D print file specifying the 3D object for printing on the 3D printer;
store on the one or more computer readable storage media, by the processor, the 3D print file with the specification of the technique and the location for printing the sensor as part of the 3D object added to the 3D print file specifying the 3D object for printing on the 3D printer; and
send the 3D print file to the 3D printer.

19. The system of claim 18, the program instructions further executable to print on the 3D printer the 3D print file with the specification of the technique and the location for printing the sensor as part of the 3D object added to the 3D print file specifying the 3D object for printing on the 3D printer.

20. The system of claim 18, wherein the program instructions executable to identify, by the computing device, the technique for printing the sensor as part of the 3D object from the plurality of techniques for printing the sensor as part of the 3D object comprise program instructions executable to:
receive, by the processor, at least one operational attribute of each of the plurality of techniques for printing the sensor as part of the 3D object and of the 3D object;
compare, by the processor, the at least one operational attribute of the 3D object with the at least one operational attribute of each of the plurality techniques for printing the sensor as part of the 3D object; and
select, by the processor, from the plurality of techniques for printing the sensor as part of the 3D object a technique for printing the sensor directly onto the structure of the 3D object, based on the comparison.
